(19) United States
(12) Patent Application Publication
(10) Pub. No.: US 2026/0346715 A1
(43) Pub. Date: Nov. 5, 2026

(54) HEAD-UP DISPLAY DEVICE AND DISPLAY CONTROL SYSTEM

(71) Applicant: Nippon Seiki Co., Ltd., Niigata (JP)

(72) Inventors: Masaki Katagiri, Niigata (JP); Takeru Hayashi, Niigata (JP); Hanako Honma, Niigata (JP)

(21) Appl. No.: 19/488,142

(22) PCT Filed: Jun. 6, 2024
(86) PCT No.: PCT/JP2024/020766

§ 371 Date: Nov. 26, 2025

(30) Foreign Application Priority Data
Jun. 7, 2023 (JP) 2023-093744

(51) Int. Cl. B60K 35/231; B60K 35/29; B60K 35/81; G02B 27/01

(52) U.S. Cl. CPC B60K 35/231; B60K 35/29; B60K 35/81; G02B 27/0101; B60K 2360/166; B60K 2360/167; G02B 2027/011; G02B 2027/013

(57) ABSTRACT

A head-up display device includes a display unit that projects first and second virtual images in a display area; and a control unit that controls display of, on the display unit, the first virtual image and the second virtual image disposed below the first virtual image. If the first and second virtual images are treated mutually related information, the control unit sets the spacing between the lower end of the first virtual image and the upper end of the second virtual image to less than or equal to a threshold determined by the difference between an image formation distance from the viewpoint of a viewer to the lower end of the first virtual image in the display area and an image formation distance from the viewpoint of the viewer to the upper end of the second virtual image, and displaying the first and second virtual images on the display unit.

### TECHNICAL FIELD

The present invention relates to a head-up display device or the like that is used in a moving object such as a vehicle and causes a virtual display object to be superimposed on a front scenery of the moving object and visually recognized.

### BACKGROUND ART

For example, Patent Document 1 describes a head-up display device (hereinafter, simply referred to as an HUD device) that enhances expressiveness in a depth direction (a front-rear direction of a vehicle) by using a virtual display object (virtual image) and enables intuitive information presentation to a viewer (a driver or the like). The HUD device forms augmented reality (AR: Augmented Reality) in which a virtual image is arranged at a predetermined position in a depth direction or vertical and horizontal directions in a space of the front scenery (an actual scenery in a forward direction viewed from a viewer of a vehicle), and the virtual image is added to a real scenery (front scenery) such as a road surface and displayed.

### PRIOR ART DOCUMENT

### Patent Document

Patent Document 1: Japanese Unexamined Patent Application Publication No. 2021-051231

### SUMMARY OF THE INVENTION

According to the technique described in Patent Document 1, the HUD device can make the viewer feel the depth by using an inclined image formation plane. As a result, the images arranged in the vertical direction are visually recognized as if they are arranged at different distances, which is advantageous in that the information can be easily distinguished.

Here, for example, the case where the distance difference between the upper end and the lower end of the image formation plane is large is considered. As described above, when two images are arranged in the vertical direction, they are visually recognized as if they are at different distances and, for example, even when two images having one meaning, such as a sign for vehicle speed limit and a number indicating a vehicle speed of a traveling vehicle, are displayed, they are visually recognized as two pieces of information arranged at different distances depending on how the images are arranged, and in this case, it may be difficult to correctly transmit the display contents of the images to the viewer.

For this reason, when images are displayed by an HUD device having an inclined image formation plane, it is necessary to clarify the boundary regarding how far the images need to be arranged from each other to appear to be two pieces of information or, conversely, how close the images need to be arranged to each other to appear to be one piece of information. Thus, an object of the present invention is to provide a head-up display device and a display control system that enable accurate information transmission by clarifying a spacing between virtual images when arranging the virtual images with which it is possible to perceive that the two virtual images mean one piece of information.

Other objects of the present invention will become apparent to those skilled in the art by referring to the following aspects, the best embodiment, and the accompanying drawings.

### SOLUTION TO PROBLEM

Hereinafter, in order to easily understand the outline of the present invention, aspects according to the present invention will be exemplified.

In a first aspect, a head-up display device projects and displays a virtual image in a display area virtually set in front of a vehicle in a superimposed manner on a front scenery and thus causes a viewer to visually recognize the virtual image, the head-up display device includes: a display unit that projects and displays a first virtual image and a second virtual image in the display area; and a control unit that performs control to display, on the display unit, the first virtual image arranged in the display area and the second virtual image arranged below the first virtual image, and when the first virtual image and the second virtual image are treated as information related to each other, and the control unit sets a spacing between a lower end of the first virtual image and an upper end of the second virtual image arranged in the display area to be equal to or less than a predetermined threshold determined by a difference between an image formation distance from a viewpoint position of the viewer to the lower end of the first virtual image in the display area and an image formation distance from the viewpoint position of the viewer to the upper end of the second virtual image, and performs control to display the first virtual image and the second virtual image on the display unit.

Here, the “information related to each other” refers to the information in which the two virtual images have different meanings although they are related to each other or the information in which it is difficult to present one piece of information unless the other piece of information is present. As illustrated in an example of the display form in FIG. 10(a), it corresponds to a sign VS3 for vehicle speed limit and a number VS1 that is arranged below it and indicates the vehicle speed of a traveling vehicle 10, or an arrow VN1 indicating a turn at the next intersection in a route guidance by a navigation device and a number VN2 indicating the remaining distance to it. In this case, the “first virtual image” is the sign VS3 for vehicle speed limit or the arrow VN1, and the “second virtual image” is the number VS1 indicating the vehicle speed or the number (VN2) indicating the remaining distance, and in each case, the second virtual image is arranged below the first virtual image.

The “viewpoint position of the viewer” refers to, for example, an eye point EP of the viewer (the center of an eye box defined based on a virtual line connecting the eye of the viewer and the outer edge of a display area VA) as illustrated in FIG. 1(a). The “predetermined threshold” is a value determined by the difference between the image formation distance from the viewpoint position EP of the viewer to the lower end of the first virtual image V1 in the display area VA and the image formation distance from the viewpoint position EP of the viewer to the upper end of the second virtual image V2. In other words, it is a spacing (clearance) between the virtual images V at which the viewer can perceive that the first virtual image V1 and the second virtual image V2 present one piece of information and is a value determined by measurement or simulation by the inventor or the like, for example, as illustrated in FIG. 7(a)(b) and FIG. 8(a)(b) that indicates evaluation results regarding the clearance between the first virtual image V1 and the second virtual image V2.

According to the first aspect, when the first virtual image V1 and the second virtual image V2 are treated as information related to each other, the control unit sets the spacing (clearance) between the lower end of the first virtual image V1 and the upper end of the second virtual image V2 arranged in the display area VA to be equal to or less than a predetermined value determined by the difference between the image formation distance from the viewpoint position EP of the viewer to the lower end of the first virtual image V1 in the display area VA and the image formation distance from the viewpoint position EP of the viewer to the upper end of the second virtual image V2, and performs control to display the first virtual image V1 and the second virtual image V2 on the display unit. In this way, the first virtual image V1 and the second virtual image V2 can be appropriately arranged in accordance with the spacing (clearance) between the virtual images with which it is possible to perceive that the two virtual images V1 and V2 mean one piece of information, and accordingly, the accurate information can be transmitted to the viewer.

In a second aspect according to the first aspect, the control unit may treat the first virtual image and the second virtual image as information that have a meaning using at least the two virtual images and are related to each other.

For example, in FIG. 10(a), the sign VS3 (the first virtual image) for vehicle speed limit and the vehicle speed VS1 (the second virtual image) arranged below it are illustrated as information related to each other, but they are examples in which, when one of them is not displayed, it is difficult to convey the meaning of the display of the other. In other words, even when the sign VS3 (the first virtual image) for vehicle speed limit is displayed while the vehicle 10 is traveling, it is not possible to know whether the vehicle 10 can travel while complying with the vehicle speed VS1 (the second virtual image). Therefore, according to the second aspect, the control unit treats the first virtual image V1 and the second virtual image V2 as the information that have a meaning using at least the two virtual images and are related to each other. As described above, in the case where such exemplified information is visually recognized by the viewer, it is possible to reduce the load of information recognition when the information is presented as one piece of information instead of independent pieces of information. In other words, instantaneous visual recognition of traveling at 100 km/h on the road with the speed limit of 80 km/h makes it possible to quickly induce the next action of the viewer, such as reducing the traveling speed.

In a third aspect according to the first or second aspect, the control unit may set the predetermined threshold such that a vertical component of an angle of view indicating the spacing between the lower end of the first virtual image and the upper end of the second virtual image is 0.6° or less.

For example, as illustrated in FIG. 1(a), when a virtual range in a space in which an image (the virtual image V) can be formed is an image formation plane (the display area VA), an angle of view AV (Angle of View) is, for example, a visual angle (Visual Angle) defined based on the virtual line connecting the viewpoint position EP of the viewer (eye point: the center of an eye box defined based on the virtual line connecting the eyes of the viewer and an outer edge of the display area VA) and the outer edge of the display area VA. The angle of view AV is an angle range in which the viewer can visually recognize the image (the virtual image V) when viewed from the viewpoint position EP of the viewer, and a front range overlapping the display area VA which is an image formation plane when viewed from the viewpoint position EP is the range of the angle of view AV. The clearance described above is indicated by a vertical angle of view which is a vertical component of the angle of view.

For example, FIG. 7 illustrates evaluation contents regarding the spacing (clearance) between the first virtual image V1 and the second virtual image V2. FIG. 7(a) illustrates the result when the measurement was performed by setting the vertical component of the angle of view AV indicating the clearance to about 3°, FIG. 7(b) illustrates the result when the measurement was performed by setting the vertical component of the angle of view AV indicating the clearance to about 2°, and FIG. 7(c) illustrates an example of the two virtual images V1 and V2 arranged in the display area VA for evaluation.

Specifically, for evaluation, as illustrated in FIG. 7(c), the first virtual image V1 was fixed at the upper end of the display area VA, the second virtual image V2 was gradually separated from the first virtual image V1 in a downward direction to increase the clearance between the images, and, in the process of separation, the subject was asked the question “Do the two virtual images appear to be the identical information group?”, and the rate of the number of people who answered “they appear” was measured. The measurement results are illustrated as graphs in FIG. 7(a)(b).

FIG. 7(a) is a graph illustrating the result when the measurement was performed by setting the vertical component of the angle of view AV indicating the clearance to about 3°, and FIG. 7(b) is a graph illustrating the result when the measurement was performed by setting the vertical component of the angle of view AV indicating the clearance to about 2°. In the graphs illustrated in FIG. 7(a)(b), the solid line indicates the measurement result in the case of using the 4-8 m image formation plane (the image formation distance from the viewpoint position EP of the viewer to the upper end of the display area VA is 8 m, and the image formation distance from the viewpoint position EP of the viewer to the lower end of the display area VA is 4 m), and the broken line indicates the measurement result in the case of using the 2-3 m image formation plane (the image formation distance from the viewpoint position EP of the viewer to the upper end of the display area VA is 3 m, and the image formation distance from the viewpoint position EP of the viewer to the lower end of the display area VA is 2 m). The horizontal angle of view (horizontal component of the angle of view) is fixed to 7° in all the patterns.

According to the graphs illustrated in FIG. 7(a)(b), it can be understood that, when the vertical component of the angle of view AV indicating the spacing (clearance) between the images exceeds 0.8°, they cannot be visually recognized as the identical information group and, when a smaller value is set, they are visually recognized as the identical information group at a higher rate. Further, it can be understood that, when the vertical component of the angle of view AV indicating the clearance is 0.4° or less, the majority of the subjects can visually recognize them as the identical information group. From this measurement result, it can be determined that it is preferable to set the clearance to the threshold “0.6° or less”.

Furthermore, since the vehicle speed display and the display for the remaining fuel are often displayed in a lower area (on the near side when viewed from the viewer) of the display area VA, it is also necessary to perform the same measurement in the case of separation in the upward direction in the display area VA while the virtual image V is fixed in the lower area of the display area VA. For example, FIG. 8 (FIG. 8(a)(b)) illustrates evaluation contents regarding the clearance between the first virtual image V1 and the second virtual image V2.

FIG. 8(a) illustrates the result when the measurement was performed by setting the vertical component of the angle of view AV indicating the clearance to about 3°, FIG. 8(b) illustrates the result when the measurement was performed by setting the vertical component of the angle of view AV indicating the clearance to about 2°, and FIG. 8(c) illustrates an example of the two virtual images V1 and V2 arranged in the display area VA for evaluation.

For the measurement, as illustrated in FIG. 8(c), the second virtual image V2 was fixed at the lower end of the display area VA, the first virtual image V1 was gradually separated from the second virtual image V2 in an upward direction to increase the clearance between the images and, in the process of separation, the subject was asked the question “Do the two virtual images appear to be the identical information group?”, and the rate of the number of people who answered “they appear” was measured. The results are illustrated as graphs in FIG. 8(a)(b).

FIG. 8(a) is a graph illustrating the result when the measurement was performed by setting the vertical component of the angle of view AV to about 3°, and FIG. 7(b) is a graph illustrating the result when the measurement was performed by setting the vertical component of the angle of view AV to about 2°. In the graphs illustrated in FIG. 8(a)(b), the solid line indicates the result in the case of using the 4-8 m image formation plane (the image formation distance from the viewpoint position EP of the viewer to the upper end of the display area VA is 8 m, and the image formation distance from the viewpoint position EP of the viewer to the lower end of the display area VA is 4 m), and the broken line indicates the result in the case of using the 2-3 m image formation plane (the image formation distance from the viewpoint position EP of the viewer to the upper end of the display area VA is 3 m, and the image formation distance from the viewpoint position EP of the viewer to the lower end of the display area VA is 2 m). The horizontal angle of view (horizontal component of the angle of view) is fixed to 7° in all the patterns.

According to the graphs of FIG. 8(a)(b), it can be understood that, when the vertical component of the angle of view indicating the clearance exceeds 1.2°, they cannot be visually recognized as the identical information group and, when a smaller value is set, they are visually recognized as the identical information group at a higher rate. Further, it can be understood that, when the vertical component of the angle of view AV indicating the clearance is 0.4° or less, the majority of the subjects can visually recognize them as the identical information group. From this measurement result, it can be determined that it is preferable to set the vertical component of the angle of view AV indicating the clearance to 0.6° or less.

According to the third aspect, the control unit sets the predetermined threshold such that the vertical component of the angle of view AV indicating the spacing (clearance) between the lower end of the first virtual image V1 and the upper end of the second virtual image V2 is 0.6° or less. As described above, the arrangement of the virtual images V1 and V2 is designed such that the clearance between the virtual images V1 and V2 is 0.6° or less regardless of where the first virtual image V1 and the second virtual image V2 are arranged in the display area VA, which is virtually set in front of the vehicle 10, so that many viewers can perceive them as the identical information group. In other words, the virtual images V1 and V2 can be appropriately arranged in accordance with the clearance (the vertical component of the angle of view AV is 0.6° or less) with which it is possible to perceive that the two virtual images V1 and V2 mean one piece of information, and accordingly, the accurate information can be transmitted to the viewer.

In a fourth aspect according to the first to third aspects, when an end portion of the display area on a side closer to the viewer is set as a lower end and an end portion on a farther side is set as an upper end, the control unit may perform control so that the display area is displayed to be visually recognized by the viewer in an inclined manner such that the upper end is closer to a back side than the lower end.

According to the fourth aspect, the control unit can perform display with enhanced expressiveness in the depth direction (the front-rear direction of the vehicle) by using the display area VA that is an inclined image formation plane in which the upper end (for example, the upper end PU of the angle of view AV in FIG. 1(b)) of the display area VA is closer to the back side than the lower end (for example, the lower end PL of the angle of view AV in FIG. 1(b)) and can realize visibility of a more natural and perspective image.

In a fifth aspect according to the first to fourth aspects, the control unit may set a convergence angle difference, which is a difference between a first convergence angle with respect to a first point at an upper end of the display area and a convergence angle with respect to a second point at a lower end of the display area, to 1.0° or less.

Here, the “convergence angle” is an angle formed by the lines of sight (two lines of sight) of both eyes when gazing at the virtual image V arranged in the display area VA, is small when gazing at the distant virtual image V, and increases as gazing at the near virtual image V. For example, FIG. 4 is a conceptual diagram illustrating the convergence angle and the convergence angle difference. In the head-up display device, the lower end PL of the display area VA appears to be closer to the viewer than the upper end PU. As a result, a difference occurs between the values of a first convergence angle θL with respect to a first point R1 and a second convergence angle θU with respect to a second point R2. The difference α=θL−θU is a positive value. This difference α is herein referred to as a “convergence angle difference”.

In addition, in the head-up display device, it is known that a phenomenon occurs in which the shape of the entire virtual image arranged in the display area VA is visually recognized as being changed (deformed) due to binocular parallax or motion parallax caused by viewpoint movement of the viewer such as a driver because the display area VA is inclined. For example, FIG. 5 is a diagram cited for illustrating the deformation of the image formation plane. FIG. 5(a), FIG. 5(b), and FIG. 5(c) illustrate how the display area (VA) appears when the center of both eyes of the viewer is at a point A1, when the center of both eyes of the viewer is at a point C, and when the center of both eyes of the viewer is at a point A2, respectively. This is different from the distortion of the virtual image caused by the aberration due to the free-form surface shape of a windshield 13 (FIG. 1(a)) or the eccentricity of an optical component. There is a known phenomenon in which the deformation occurs in the entire virtual image V and the viewer is likely to feel a sense of discomfort with respect to the deformation occurring in the virtual image V. However, it is also known that this deformation is allowable when the distance difference between the upper end PU and the lower end PL of the display area VA falls within a certain range.

Here, the allowable range of the distance difference between the upper end PU and the lower end PL of the head-up display device will be described with reference to FIG. 6. FIG. 6 illustrates a measurement result indicating an allowable rate of deformation when the virtual image V is arranged in the display area VA in the image formation plane in which various convergence angle differences α are set. Here, in the graph, the solid line indicates the allowable rate of deformation when the upper end PU of the display area VA is fixed at about 8 m (the image formation distance from the viewpoint position EP of the viewer to the upper end PU of the display area VA) and the distance from the lower end PL is changed, and the broken line indicates the allowable rate when the upper end PU of the display area VA is fixed at about 3.4 m (the image formation distance from the viewpoint position EP of the viewer to the lower end PL of the display area VA) and the distance from the lower end PL is changed.

According to the graph illustrated in FIG. 6, when the convergence angle difference α takes a value larger than 1°, even in two different distance zones, it is expected that all of the subjects answer that the deformation is not allowable. In addition, when the convergence angle difference α is 1° or less, the number of subjects who feel that it is not allowable decreases as the convergence angle difference α decreases. From this, it is considered that the convergence angle difference α between the upper end PU and the lower end PL of the display area VA in the head-up display device is desirably 1° or less. In addition, it is understood that, by setting the convergence angle difference α to 0.7° or less, the deformation is allowable for more than half of the people. That is, it can be considered that setting the convergence angle difference α to 0.7° or less can sufficiently obtain an effect of preventing a feeling of discomfort due to the deformation of the virtual image V.

According to the fifth aspect, the control unit sets the convergence angle difference α, which is the difference between the first convergence angle with respect to the first point R1 at the upper end PU of the display area VA and the convergence angle with respect to the second point R2 at the lower end PL of the display area VA, to 1.0° or less. Accordingly, in the head-up display device in which the display area VA (image formation plane) is inclined, it is possible to sufficiently obtain the effect to the extent that a sense of discomfort due to the deformation of the virtual image V is prevented even when the shape of the entire virtual image arranged in the display area VA is deformed due to the binocular parallax or the motion parallax caused by the viewpoint movement of the driver who is the viewer. As specific specifications, this range includes the type in which the image formation distance from the viewpoint position EP of the viewer to the upper end PU of the display area VA is about 8 m and the image formation distance to the lower end PL of the display area VA is about 4 m, or the type in which the image formation distance to the upper end PU of the display area VA is about 3 m and the image formation distance to the lower end PL of the display area VA is about 2 m. Actually, the convergence angle difference α formed by the former display area VA is about 0.47°, and the convergence angle difference α formed by the latter display area VA is about 0.62°.

The convergence angle difference α is represented by an angle such as 0.5° in the same manner as the clearance described above, but the convergence angle difference α is determined by the image formation distance from the viewpoint position EP of the viewer to the upper end PU of the display area VA and the image formation distance from the viewpoint position EP of the viewer to the lower end PL of the display area VA and is “the amount for determining the specification (the difference between the distance from the viewpoint position EP of the viewer to the upper end PU of the display area VA and the distance to the lower end PL to prevent the viewer from feeling discomfort due to the deformation of the virtual image V) of the head-up display device” while the clearance is determined by the difference between the image formation distance from the viewpoint position EP of the viewer to the lower end of the virtual image V1 in the display area VA and the image formation distance from the viewpoint position EP of the viewer to the upper end of the virtual image V2 and is “the amount for determining the specific arrangement of the virtual images V1 and V2 in the display area VA when they are treated as related information”.

According to a sixth aspect, a display control system includes: a head-up display device that projects and displays a virtual image in a display area virtually set in front of a vehicle in a superimposed manner on a front scenery; and a processing device that generates the virtual image, and the head-up display device includes a display unit that projects and displays a first virtual image and a second virtual image in the display area, and a control unit that performs control to display, on the display unit, the first virtual image arranged in the display area and the second virtual image arranged below the first virtual image, and when the first virtual image and the second virtual image are treated as information related to each other, the processing device sets a spacing between a lower end of the first virtual image and an upper end of the second virtual image arranged in the display area to be equal to or less than a predetermined threshold determined by a difference between an image formation distance from a viewpoint position of the viewer to the lower end of the first virtual image in the display area and an image formation distance from the viewpoint position of the viewer to the upper end of the second virtual image and gives an instruction to the head-up display device to display the first virtual image and the second virtual image.

According to the sixth aspect, when the first virtual image V1 and the second virtual image V2 are treated as information related to each other, the processing device sets the spacing between the lower end of the first virtual image V1 arranged in the display area VA and the upper end of the second virtual image V2 to be equal to or less than a predetermined value determined by the difference between the image formation distance from the viewpoint position of the viewer to the lower end of the first virtual image V1 in the display area VA and the image formation distance from the viewpoint position of the viewer to the upper end of the second virtual image V2 and performs control to display the first virtual image V1 and the second virtual image V2 on the display unit. As described above, it is possible to provide a display control system capable of appropriately arranging the first virtual image V1 and the second virtual image V2 in accordance with the spacing (clearance) between the virtual images with which it is possible to perceive that the two virtual images V1 and V2 mean one piece of information, and accordingly, transmitting the accurate information to the viewer. Those skilled in the art will readily appreciate that the aspects according to the present invention illustrated may be further modified without departing from the spirit of the present invention.

### BRIEF DESCRIPTION OF THE DRAWINGS

FIG. 1 is a diagram illustrating an application example of a head-up display device according to an embodiment of the present invention to a vehicle, FIG. 1(a) is a diagram cited for illustrating the relationship between a viewpoint position of a viewer and a display area, and

FIG. 1(b) is a diagram cited for illustrating the relationship between the display area (image formation plane) virtually set in front of the vehicle and an angle of view.

FIG. 2 is a block diagram illustrating a configuration of a vehicle control system to which the head-up display device according to the embodiment of the present invention is applied.

FIG. 3 is a diagram illustrating a cross-sectional structure of the head-up display device according to the embodiment of the present invention, FIG. 3(a) illustrates the state of rotation of a reflective member (concave mirror) when an eye box is at a reference position, and FIG. 3(b) illustrates the state of rotation of the reflective member (concave mirror) when the position of the eye box is raised.

FIG. 4 is a conceptual diagram illustrating a convergence angle and a convergence angle difference.

FIG. 5 is a diagram cited for illustrating deformation of an image due to inclination of an image formation plane.

FIG. 6 is a graph illustrating a relationship between a convergence angle difference and an allowable rate of deformation used in the head-up display device according to the embodiment of the present invention.

FIG. 7 illustrates an example of evaluation contents regarding the clearance between a first virtual image and a second virtual image arranged in the display area in the head-up display device according to the embodiment of the present invention, FIG. 7(a) illustrates the result when the measurement was performed by setting a vertical component of the angle of view indicating the clearance to about 3°, FIG. 7(b) illustrates the result when the measurement was performed by setting the vertical component of the angle of view indicating the clearance to about 2°, and FIG. 7(c) illustrates an example of the two virtual images arranged in the display area for measurement.

FIG. 8 illustrates another example of measurement contents regarding the clearance between the first virtual image and the second virtual image arranged in the display area in the head-up display device according to the embodiment of the present invention, FIG. 8(a) illustrates the result when the measurement was performed by setting the vertical component of the angle of view indicating the clearance to about 3°, FIG. 8(b) illustrates the result when the measurement was performed by setting the vertical component of the angle of view indicating the clearance to about 2°, and FIG. 8(c) illustrates an example of the two virtual images arranged in the display area for measurement.

FIG. 9 is a flowchart illustrating an operation of the head-up display device according to the embodiment of the present invention.

FIG. 10 is a diagram illustrating a display form of the virtual image by the head-up display device according to the embodiment of the present invention, FIG. 10(a) illustrates an example of the display form, and FIG. 10(b) illustrates another example of the display form.

### MODE FOR CARRYING OUT THE INVENTION

The best embodiment described below is used for easy understanding of the present invention. Therefore, it should be noted by those skilled in the art that the present invention is not unreasonably limited by the embodiment described below (hereinafter referred to as the present embodiment).

Hereinafter, a vehicle control system 1000 to which a head-up display device according to the present embodiment is applied will be exemplified and described with reference to the accompanying drawings.

### Configuration of Embodiment

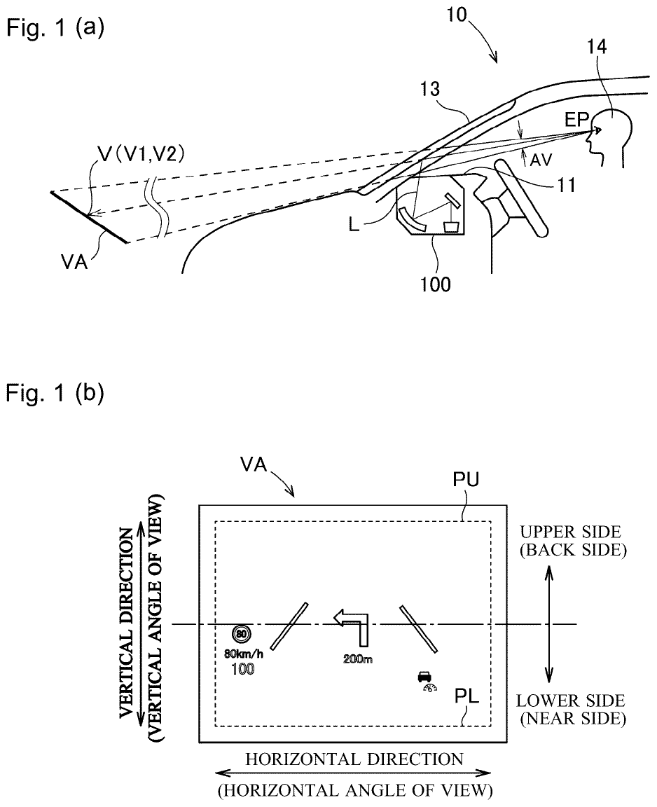

FIG. 1 is a diagram illustrating an application example of a head-up display device (hereinafter, referred to as an HUD device 100) according to the present embodiment to a vehicle 10, FIG. 1(a) is a diagram cited for illustrating the relationship between a viewpoint position of a viewer in a height direction and a display area VA, and FIG. 1(b) is a diagram cited for illustrating the relationship between the display area VA (image formation plane) virtually set in front of the vehicle 10 and an angle of view AV.

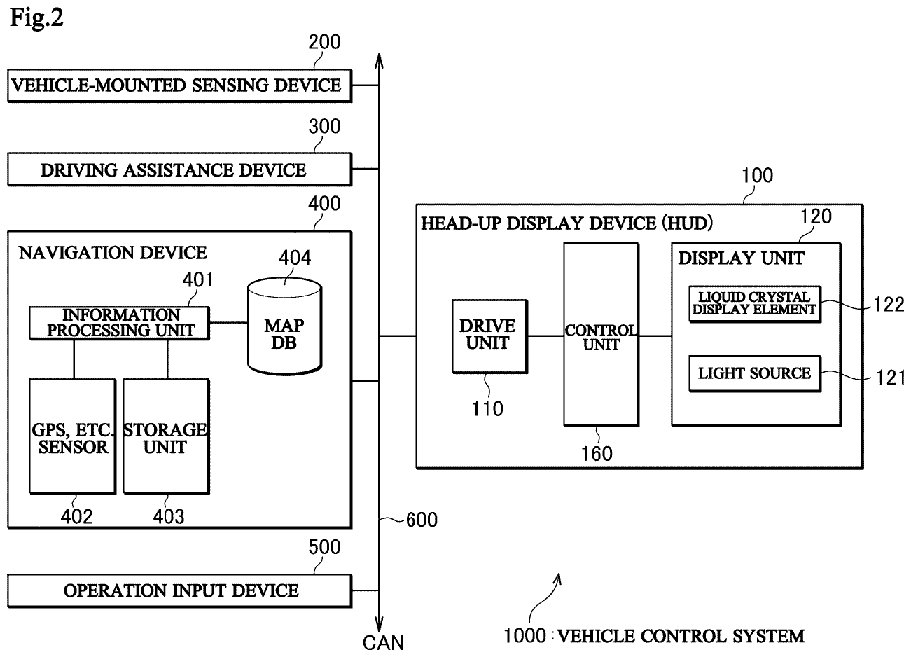

As illustrated in FIG. 1(a), the projection display by the HUD device 100 is to display an image (virtual image V) by reflecting display light L projected by the HUD device 100 provided inside an instrument panel 11 of the vehicle 10 in a direction of a viewer 14 of the vehicle 10 (a driver seated on a driver's seat of the vehicle 10) by a windshield 13 of the vehicle 10. In other words, the HUD device 100 projects the display light L (image) emitted from a display unit (120 in FIG. 2 to be described below) onto the windshield 13, which is a projection target member, and causes the viewer to visually recognize the display light L (image) in response to the projection. Thus, the viewer can visually recognize the image (the virtual image V) superimposed on the scenery in front of the vehicle 10.

In this case, the HUD device 100 projects the display light L such that the image (the virtual image V) is inclined at 45° or less with respect to the road surface on which the vehicle 10 travels and the upper portion of the image (the virtual image V) appears to be inclined to the side farther from the viewer than the lower portion. As a result, the viewer can visually recognize the image (the virtual image V) mainly displayed on the road surface in a superimposed manner on the front side of the vehicle 10 and can obtain various kinds of information indicated by the content of the image.

The angle of view AV is set in the HUD device 100. When a virtual range in a space in which the image (the virtual image V) can be formed by the HUD device 100 is an image formation plane (the display area VA), the angle of view AV is a visual angle defined based on a virtual line connecting a viewpoint position EP (the eye point: the center of the eye box defined based on the virtual line connecting the eyes of the viewer and the outer edge of the display area VA) of the viewer and the outer edge of the display area VA. The angle of view AV is an angle range in which the viewer can visually recognize the image (the virtual image V) when viewed from the viewpoint position EP.

As illustrated in FIG. 1(b), in the HUD device 100, the horizontal angle of view (for example, about 10 to 12°) in the horizontal direction is set to be larger than the vertical angle of view (for example, about 4 to 5°) in the vertical direction. A front range overlapping the display area VA which is an image formation plane when viewed from the viewpoint position EP of the viewer is the range of the angle of view AV. The display area VA corresponds to a display surface 120a, which will be described below, of the HUD device 100 (in other words, the display area VA has a conjugate relation with the display surface 120a of the display unit 120, which will be described below), and the image (the virtual image V) visually recognized in the display area VA corresponds to an image projected and displayed on the display surface 120a of the HUD device 100.

In FIG. 1(b), the vertical direction of the display unit 120 is a vertical angle of view, and the horizontal direction is a horizontal angle of view. In the display area VA, an area between an upper end PU and a lower end PL of the angle of view AV is divided into two equal parts by a boundary line (a dash-dotted line in the drawing), and the lower side (the side perceived as a near side when viewed from the viewer) of the area divided by it can be defined as a “near side”, and the upper side (the side perceived as a far side when viewed from the viewer) can be defined as a “back side”. Further, the boundary line is merely an example, and this is not a limitation.

FIG. 2 is a block diagram illustrating a configuration example of the vehicle control system 1000 to which the HUD device 100 according to the present embodiment is applied.

As illustrated in FIG. 2, the vehicle control system 1000 includes the HUD device 100, a vehicle-mounted sensing device 200, a driving assistance device 300, a navigation device 400, and an operation input device 500. Each of these enables bidirectional information transmission via a CAN (Control Area Network) 600, which is an in-vehicle LAN.

The vehicle-mounted sensing device 200 is sensors necessary for recognizing the surrounding traveling environment including the front of the vehicle 10 and includes a camera, a LiDAR (Light Detection And Ranging), and the like. Further, it also includes an IMU (Inertial Measurement Unit) that detects the behavior of the vehicle 10, a vehicle speed sensor, and the like. Information recognized or detected by the vehicle-mounted sensing device 200 is transferred to the driving assistance device 300, the navigation device 400, and the HUD device 100 according to the present embodiment via the CAN 600.

Further, the camera captures at least the front field of view (actual scenery) of the vehicle 10, and the LiDAR uses near-infrared light, visible light, or ultraviolet light to, for example, irradiate an obstacle or the like present in front of the vehicle 10 captured by the camera with light, captures the reflected light with an optical sensor, and determines the distance to the obstacle based on the time difference. The IMU can measure the driving situation and posture of the vehicle (detect the translational motion in three axial directions from the acceleration [m/s²] and the rotational motion from the angular velocity [deg/s]) by using a three-axis acceleration sensor and a three-axis angular velocity sensor (gyro sensor).

The driving assistance device 300 includes at least one of a driving assistance function by an ADAS (Advanced Driver-Assistance System) such as an LKAS (Lane Keeping Assist System: lane keeping system) or an ACC (Adaptive Cruise Control System: inter-vehicle distance control device), which assists a driving operation of a driver who is a viewer, and an automatic driving function capable of performing a driving operation on driver's behalf. Further, the driving assistance device 300 can recognize or detect the traveling environment in front of the vehicle 10 and the behavior based on the information acquired from the vehicle-mounted sensing device 200 and, in accordance with the analysis result of the information acquired here, control the vehicle 10 (a driving system, a braking system, and a steering system (not illustrated)) and also can transfer the analysis result of the information to the HUD device 100, the navigation device 400, and the like, via the CAN 600.

The navigation device 400 uses a global navigation satellite system (GNSS: Global Navigation Satellite System) such as a GPS (Global Positioning System) or a gyro sensor (GPS, etc. sensor 402), and an information processing unit 401 obtains map information from a map DB 404 or through wireless communication with the outside of the vehicle, and performs surrounding facility guidance, route guidance, and the like for the vehicle 10. The navigation device 400 transfers a signal prompting display output to the HUD device 100 via the CAN 600 at an appropriate timing based on the guidance information.

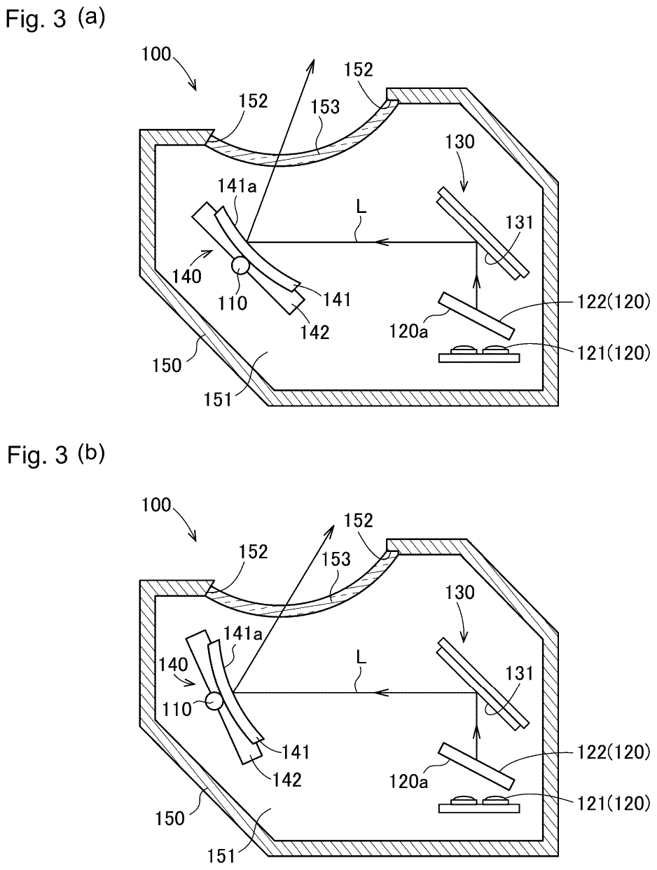

The information processing unit 401 performs information processing such as destination and facility search and guidance based on the position information of the vehicle acquired from the vehicle-mounted sensing device 200, the driving assistance device 300, the operation input device 500, and built-in sensors such as a GPS and a gyro sensor (the GPS, etc. sensor 402). Based on the result of the information processing, for example, when it is detected that the vehicle is approaching the intersection at which the vehicle is supposed to turn, the virtual image V such as an arrow indicating a right turn or a left turn at the intersection is generated and transferred to the HUD device 100. In order to control the position of the above-described eye box, the information processing unit 401 outputs, via the CAN 600, a drive signal for controlling the rotation of a concave mirror 141 (see FIG. 3(a)(b)), which is a reflective member of the HUD device 100 described below.

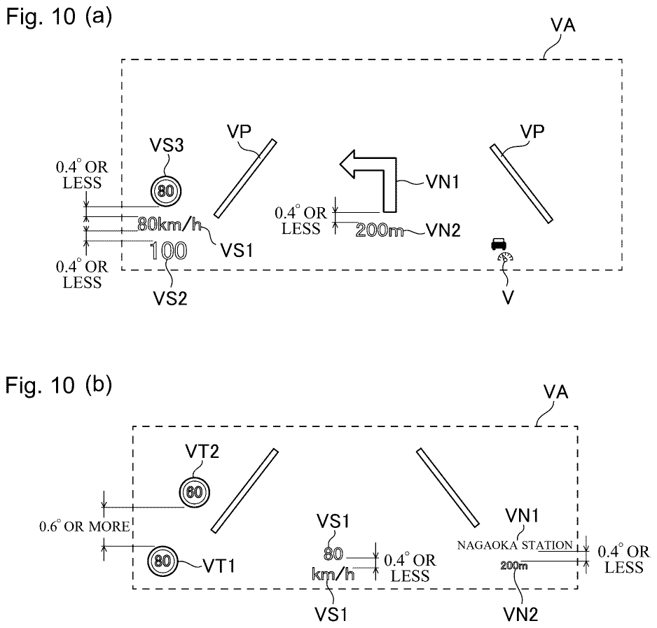

The information processing unit 401 generates an image including at least a first virtual image and a second virtual image and transmits a display command to the HUD device 100. When a sign VS3 (the first virtual image) for vehicle speed limit and a number VS1 (the second virtual image) that is arranged below it and indicates the vehicle speed of the traveling vehicle 10, or an arrow VN1 (the first virtual image) indicating a turn at the next intersection in navigation and a number VN2 (the second virtual image) indicating the remaining distance to it are treated as information related to each other, as illustrated as an example of the display form in for example FIG. 10(a) below, the HUD device 100, which has received the display command, sets the spacing between the lower end of the first virtual image and the upper end of the second virtual image arranged in the display area VA to be equal to or less than a predetermined threshold determined by the difference between the image formation distance from the viewpoint position of the viewer to the lower end of the first virtual image in the display area VA and the image formation distance from the viewpoint position of the viewer to the upper end of the second virtual image, and displays the first virtual image and the second virtual image on the display unit 120. Details will be described below.

A storage unit 403 is a memory in which, for example, a static RAM or a dynamic RAM or a flash memory or the like is mounted, to which a program area and a work area are allocated. Here, in the program area, for example, various programs necessary for destination, facility search, guidance, and the like, which are necessary for navigation, are written, and in the work area, information generated in the execution process of the above-described various programs, display information including an image to be displayed on the HUD device 100, and the like are allocated and temporarily written.

Further, the navigation device 400 includes a map database (the map DB 404). The map DB 404 can acquire and store the latest map information by, for example, communicating with an external center (not illustrated) via a V2X (Vehicle to X) type communication system (not illustrated). Here, the map information stored in the map DB 404 is mapping data that is converted into data to represent the traveling environment of the vehicle 10. The mapping data is particularly preferably digital data of a highly accurate dynamic map. The “dynamic map” is a digital map obtained by combining enormous dynamic information that changes from moment to moment, such as traffic regulations, construction information, accidents, congestion, pedestrians, and signal information, and static information such as highly accurate three-dimensional position information (road surface information, oblique line information, and three-dimensional structures).

The operation input device 500 is, for example, switches provided in the vicinity of a steering wheel (steering handle). In accordance with the operation on the switches by the viewer who is the viewer, the operation input device 500 switches on/off the HUD device 100, selects an execution function of the driving assistance device 300 that executes ADAS such as LKAS and ACC, and sets the air volume of the air conditioner and further can set the setting information (the position of the eye box) or the like for instructing a rotation operation of the reflective member (the concave mirror 141) by a drive unit 110 (see FIG. 3(a)(b)) of the HUD device 100.

The HUD device 100 includes the drive unit 110, the display unit 120, and a control unit 160.

The drive unit 110 is connected to the concave mirror 141 (see FIG. 3(a)(b)), which is a reflective member, and can rotate the concave mirror 141 to a predetermined angle position based on a control signal generated by the control unit 160. The rotational position of the concave mirror 141 in the HUD device 100 has several steps and can be adjusted within the range. The concave mirror 141 can be rotated by a predetermined number of steps corresponding to the position (setting information) of the eye box set by the operation of the operation input device 500 by using a stepping motor for rotational driving.

The drive unit 110 controls the angle fixing position of the concave mirror 141 by a rotation driving mechanism using a stepping motor, and therefore, the angle range can be set for the concave mirror 141 by a predetermined number of steps in each of the clockwise direction and the counterclockwise direction around the reference position.

The display unit 120 mainly includes a light source 121 formed of a light emitting diode mounted on a wiring board and a TFT (Thin Film Transistor Liquid Crystal) type liquid crystal display element 122 located on the emission side of (immediately above) the light source 121 to transmit illumination light from the light source 121 and form the display light L. This means that the light source 121 is provided behind the liquid crystal display element 122, and the liquid crystal display element 122 displays a predetermined image with the light emitted from the light source 121.

Further, the display unit 120 includes the display surface 120a (see FIG. 3(a)(b)) arranged obliquely with respect to the optical axis and outputs the display light L including light in the visible wavelength range and, for example, the light source 121 that emits white light can be used, and the liquid crystal display element 122 transmits the light emitted from the light source 121 to output the display light L including a desired image. The liquid crystal display element 122 forms a desired image based on display image data (drive signal) generated by a drawing operation performed by the control unit 160.

The control unit 160 can cause the display unit 120 (the liquid crystal display element 122) to display an image to be displayed based on the vehicle information or the like transferred from the driving assistance device 300 or the navigation device 400, for example, not only a guidance image such as a traveling lane WL but also the speed of the vehicle 10, the energy remaining amount, the time, the route guidance image, and the like, by using image data such as numerical values or icons. The image to be displayed is not limited to the vehicle information such as the speed of the vehicle and the remaining amount of energy, and any display form can be adopted.

For example, the control unit 160 outputs, to the liquid crystal display element 122, a drive signal prompting display to be visually recognized by a driver or the like who is a viewer, based on the image information generated and transferred by the information processing unit 401 of the navigation device 400 or the driving assistance device 300. In addition, the control unit 160 is also connected to the light source 121 that illuminates the liquid crystal display element 122 in a transmissive manner, and can perform turning on and off, luminance adjustment, or the like by outputting a driving signal.

When the first virtual image V1 and the second virtual image V2 are treated as information related to each other, the control unit 160 can set the spacing (clearance) between the lower end of the first virtual image V1 and the upper end of the second virtual image V2 arranged in the display area VA to be equal to or less than a predetermined threshold determined by the difference between the image formation distance from the viewpoint position EP of the viewer to the lower end of the first virtual image V1 in the display area VA and the image formation distance from the viewpoint position EP of the viewer to the upper end of the second virtual image V2 and perform control to display the first virtual image V1 and the second virtual image V2 on the display unit.

Here, the “information related to each other” refers to the information in which the two virtual images have different meanings although they are related to each other or the information in which it is difficult to present one piece of information unless the other piece of information is present and, as illustrated in an example of the display form in FIG. 10(a), corresponds to the sign VS3 for vehicle speed limit and the number VS1 that is arranged below it and indicates the vehicle speed of the traveling vehicle 10, or the arrow VN1 indicating a turn at the next intersection in the navigation and the number VN2 indicating the remaining distance to it. In this case, the “first virtual image” is the sign VS3 for vehicle speed limit and the arrow VN1, and the “second virtual image” is the number VS1 indicating the vehicle speed and the number (VN2) indicating the remaining distance, and in each case, the second virtual image is arranged below the first virtual image.

Regarding whether the control unit 160 treats the first virtual image V1 and the second virtual image V2 as information related to each other, for example, the information processing unit 401 of the navigation device 400 generates the information (flag) indicating the relationship as attribute information when generating the first virtual image V1 and the second virtual image V2 and transmits the information in association with the virtual image (V1 or V2) generated when the display command is transmitted. The HUD device 100 (the control unit 160) refers to the flag and thus performs the above-described control in a case where the first virtual image V1 and the second virtual image V2 are recognized as information related to each other.

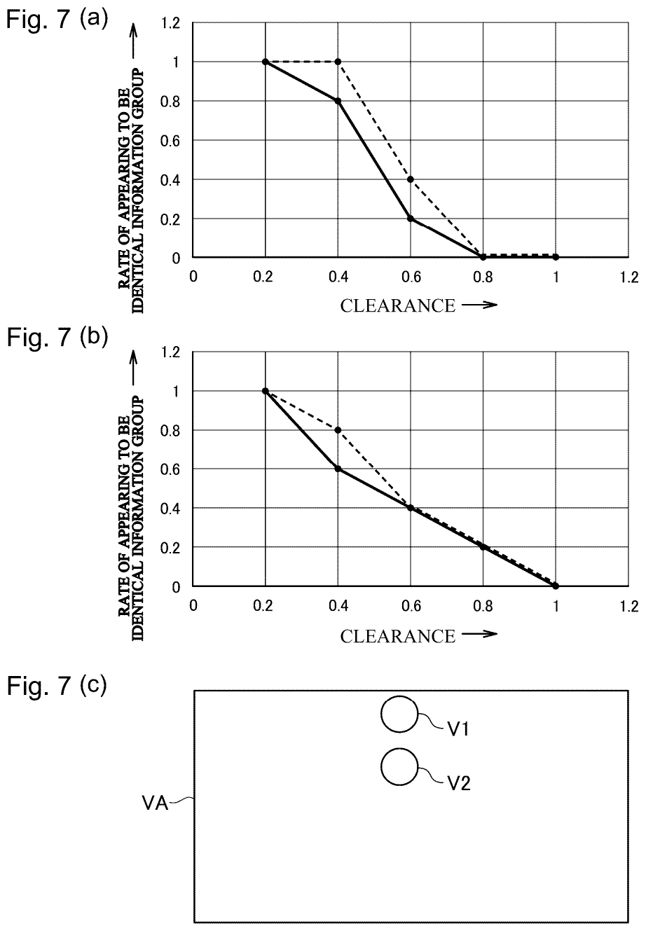

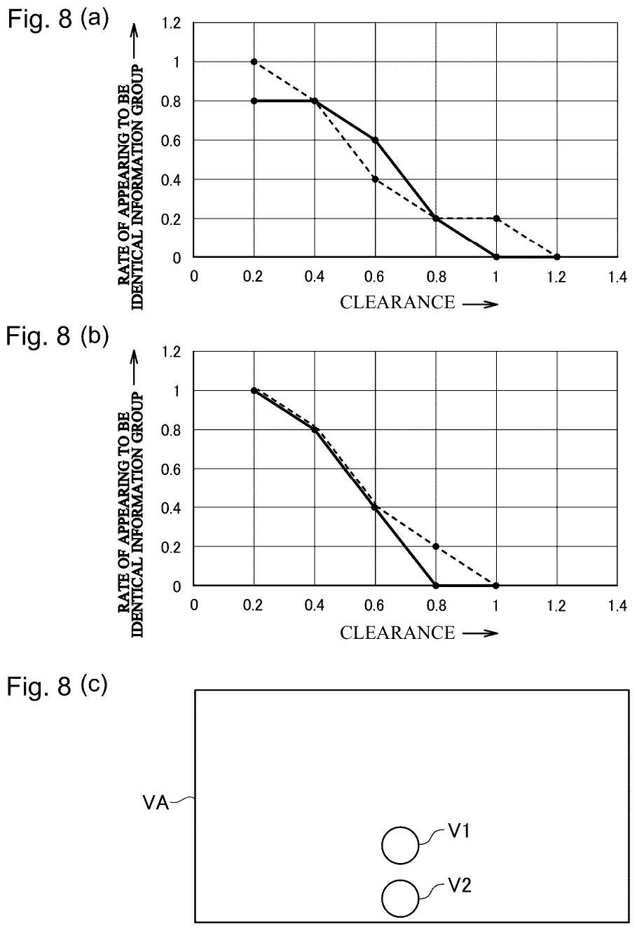

Further, the “predetermined threshold” is a value determined by the difference between the image formation distance from the viewpoint position EP of the viewer to the lower end of the first virtual image in the display area and the image formation distance from the viewpoint position EP of the viewer to the upper end of the second virtual image, in other words, the spacing (clearance) between the virtual images with which the viewer can perceive that the first virtual image V1 and the second virtual image V2 represent one piece of information, and the value determined by measurement or simulation as indicated by measurement results regarding the clearance between the first virtual image V1 and the second virtual image V2 in, for example, FIG. 7(a) (b) and FIG. 8(a)(b). Details will be described below.

The control unit 160 can also treat the first virtual image V1 and the second virtual image V2 as the information that have a meaning using at least the two virtual images and are related to each other. For example, in FIG. 10(a), the sign VS3 (the first virtual image) for vehicle speed limit and the vehicle speed VS1 (the second virtual image) arranged below it are illustrated as information related to each other, but they are examples in which, when one of them is not displayed, it is difficult to convey the meaning of the display of the other. In other words, even when the sign VS3 for vehicle speed limit is displayed while the vehicle is traveling, it is not possible to know whether the vehicle can travel while complying with the vehicle speed VS1. Therefore, the control unit 160 treats the first virtual image V1 and the second virtual image V2 as the information that have a meaning using at least the two virtual images and are related to each other and thus can reduce a load for information recognition.

The control unit 160 can also set the predetermined threshold (clearance) such that the vertical component of the angle of view AV indicating the spacing between the lower end of the first virtual image V1 and the upper end of the second virtual image V2 is 0.6° or less. For example, FIG. 7 illustrates measurement contents regarding the clearance between the first virtual image V1 and the second virtual image V2. FIG. 7(a) illustrates the measurement result when the measurement was performed by setting the vertical component of the angle of view AV indicating the clearance to about 3°, FIG. 7(b) illustrates the measurement result when the measurement was performed by setting the vertical component of the angle of view AV indicating the clearance to about 2°, and FIG. 7(c) illustrates an example of the two virtual images V1 and V2 arranged in the display area VA for measurement.

Specifically, for evaluation, as illustrated in FIG. 7(c), the first virtual image V1 was fixed at the upper end of the display area VA, the second virtual image V2 was gradually separated from the first virtual image V1 in a downward direction to increase the clearance between the images and, in the process of separation, the subject was asked the question “Do the two virtual images appear to be the identical information group?”, and the rate of the number of people who answered “they appear” was measured. The results are illustrated as graphs in FIG. 7(a)(b).

FIG. 7(a) is a graph illustrating the results when the measurement was performed by setting the vertical component of the angle of view to about 3°, and FIG. 7(b) is a graph illustrating the results when the measurement was performed by setting the vertical component of the angle of view to about 2°. In the graphs illustrated in FIG. 7(a)(b), the solid line indicates the measurement result in the case of using the 4-8 m image formation plane (the image formation distance from the viewpoint position EP of the viewer to the upper end PU of the display area VA is 8 m, and the image formation distance to the lower end PL of the display area VA is 4 m), and the broken line indicates the measurement result in the case of using the 2-3 m image formation plane (the image formation distance from the viewpoint position EP of the viewer to the upper end PU of the display area VA is 3 m, and the image formation distance to the lower end of the display area VA is 2 m). The horizontal angle of view (horizontal component of the angle of view) is fixed to 7° in all the patterns.

According to the graphs illustrated in FIG. 7(a)(b), it can be understood that, when the vertical component of the angle of view AV indicating the spacing (clearance) between the images exceeds 0.8°, they cannot be visually recognized as the identical information group and, when a smaller value is set, they are visually recognized as the identical information group at a higher rate. Further, it can be understood that, when the vertical component indicating the clearance is 0.4° or less, the majority of the subjects can visually recognize them as the identical information group. From this measurement result, it can be determined that it is preferable to set the clearance to the threshold “0.6° or less”.

Furthermore, since the vehicle speed display and the display for the remaining fuel are often displayed in a lower area (on the near side when viewed from the viewer) of the display area VA, it is also necessary to perform the same measurement in the case of separation in the upward direction in the display area while the virtual image is fixed in the lower area of the display area VA. For example, FIG. 8 illustrates evaluation contents regarding the clearance between the first virtual image V1 and the second virtual image V2. FIG. 8(a) illustrates the measurement result when the measurement was performed by setting the vertical component of the angle of view AV indicating the clearance to about 3°, FIG. 8(b) illustrates the measurement result when the measurement was performed by setting the vertical component of the angle of view AV indicating the clearance to about 2°, and FIG. 8(c) illustrates an example of the two virtual images V1 and V2 arranged in the display area VA for measurement.

For the measurement, as illustrated in FIG. 8(c), the second virtual image V2 was fixed at the lower end of the display area VA, the first virtual image V1 was gradually separated from the second virtual image V2 in an upward direction to increase the clearance between the images and, in the process of separation, the subject was asked the question “Do the two virtual images appear to be the identical information group?”, and the rate of the number of people who answered “they appear” was measured. The results are illustrated in FIG. 8(a)(b).

FIG. 8(a) is a graph illustrating the result when the measurement was performed by setting the vertical component of the angle of view AV to about 3°, and FIG. 8(b) is a graph illustrating the result when the measurement was performed by setting the vertical component of the angle of view AV to about 2°. In the graphs illustrated in FIG. 8(a)(b), the measurement indicates the measurement result in the case of using the 4-8 m image formation plane (the image formation distance from the viewpoint position of the viewer to the upper end PU of the display area VA is 8 m, and the image formation distance to the lower end PL of the display area VA is 4 m), and the broken line indicates the measurement result in the case of using the 2-3 m image formation plane (the image formation distance from the viewpoint position of the viewer to the upper end PU of the display area VA is 3 m, and the image formation distance to the lower end PL of the display area VA is 2 m). The horizontal angle of view (horizontal component of the angle of view) is fixed to 7° in all the patterns.

According to the graphs of FIG. 8(a)(b), it can be understood that, when the vertical component of the angle of view AV indicating the clearance is 1.2° or more, they cannot be visually recognized as the identical information group and, when a smaller value is set, they are visually recognized as the identical information group at a higher rate. Further, it can be understood that, when the vertical component of the angle of view AV indicating the clearance is 0.4° or less, the majority of the subjects can visually recognize them as the identical information group. From this measurement result, it can be determined that it is preferable to set the clearance to 0.6° or less.

From the above-described measurements and evaluation results, it is clear that, in the display area (VA) generated by the HUD device 100 according to the present embodiment, the first virtual image V1 and the second virtual image V2 can be visually recognized as the identical information group when the clearance is 0.6° or less wherever they are arranged in the display area VA, and when the clearance is 0.6° or more, they cannot be visually recognized as the identical information group depending on the angle of view AV of the HUD device 100 according to the present embodiment and the image formation distance at which the display area VA is generated. In view of the above, it can be considered that it is preferable to design the arrangement of the virtual images V while suppressing the clearance to 0.6° or less in a case where there is a need to cause the viewer to visually recognize them as the identical information group.

However, since a clearance of 0.6° is merely a threshold at which they can be perceived as the identical information group by the subject, it is necessary to consider the determination of the threshold for the clearance when actually performing the design. Concretely, according to the graphs illustrated in FIG. 7(a)(b) and FIG. 8(a)(b), it can be understood that 80% or more of the subjects can perceive them as the identical information group when the clearance is defined to be 0.4° or less in both of the 2-3 m image formation plane and the 4-8 m image formation plane. Therefore, in order to transmit information having the same meaning to many viewers, it can be considered that it is preferable to set the threshold for the clearance to be 0.4° or less.

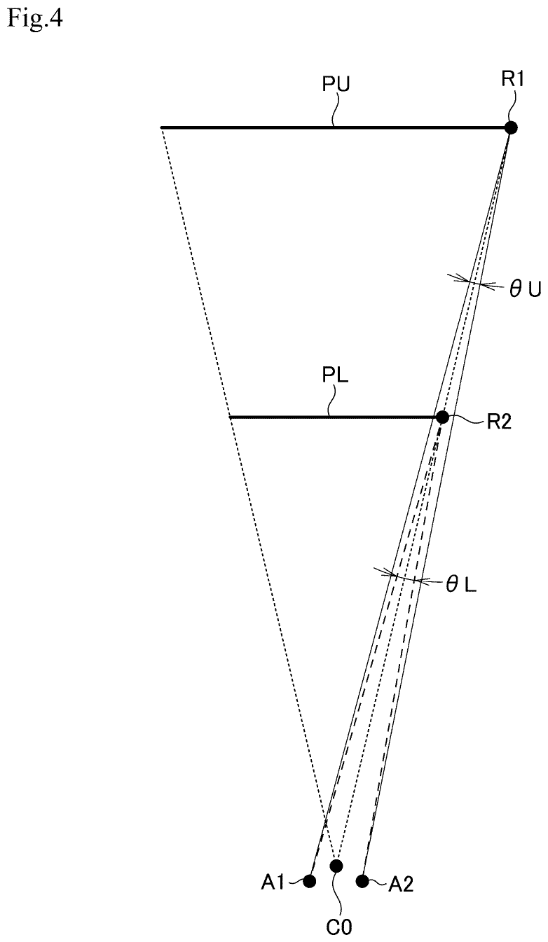

When the end portion of the display area VA on the side closer to the viewer is set as a lower end and the end portion on the farther side is set as an upper end, the control unit 160 can also perform control so that the display area VA is displayed to be visually recognized by the viewer in an inclined manner such that the upper end is closer to the back side than the lower end. The control unit 160 can perform display with enhanced expressiveness in the depth direction (the front-rear direction of the vehicle) by using the display area VA that is an inclined image formation plane in which the upper end PU (FIG. 4) of the display area VA is closer to the back side than the lower end PL (FIG. 4) and can realize visibility of a more natural and perspective image.

The control unit 160 can also set a convergence angle difference α, which is a difference between a first convergence angle with respect to a first point R1 at the upper end PU of the display area VA and a convergence angle with respect to a second point R2 at the lower end PL of the display area VA, to 1.0° or less.

Here, the “convergence angle” is an angle formed by the lines of sight (two lines of sight) of both eyes when gazing at the virtual image V arranged in the display area VA, is small when gazing at a distant virtual image, and increases as gazing at a near virtual image. For example, FIG. 4 is a conceptual diagram illustrating the convergence angle and the convergence angle difference. According to FIG. 4, the lower end PL of the display area VA in the HUD device 100 appears to be closer to the viewer than the upper end PU. As a result, a difference occurs between the values of a first convergence angle θL with respect to the first point R1 and a second convergence angle θU with respect to the second point R2. The difference α=θL−θU is a positive value. Here, a is referred to as a “convergence angle difference”.

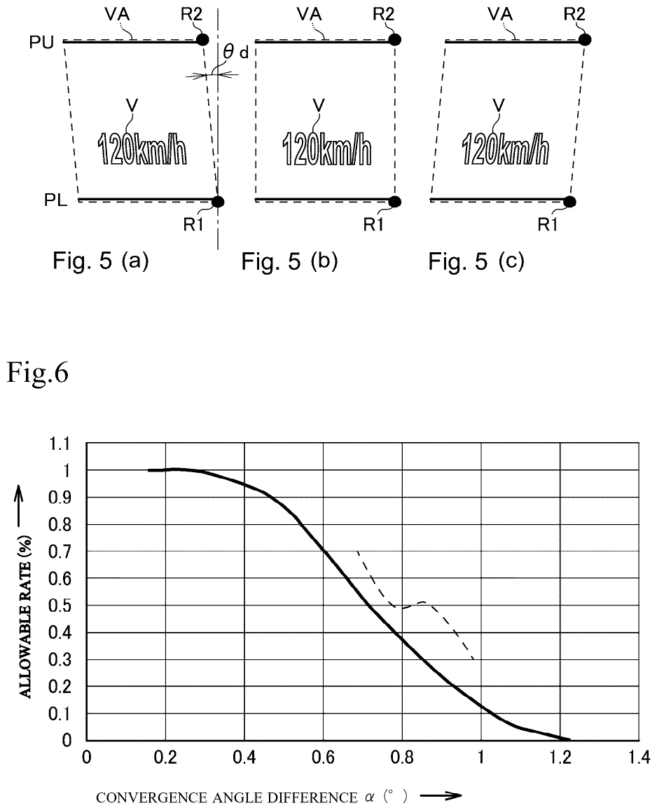

In addition, in the HUD device 100 according to the present embodiment, it is known that a phenomenon occurs in which the shape of the entire virtual image arranged in the display area VA is visually recognized as being changed (deformed) due to binocular parallax or motion parallax caused by viewpoint movement of the viewer because the display area VA (image formation plane) is inclined. For example, FIG. 5(a), FIG. 5(b), and FIG. 5(c) illustrate how the display area (VA) appears when the center of both eyes of the viewer is at a point A1 (FIG. 4), when the center of both eyes of the viewer is at a point C0 (FIG. 4), and when the center of both eyes of the viewer is at a point A2 (FIG. 4), respectively. This is different from the distortion of the virtual image caused by the aberration due to the free-form surface shape of the windshield 13 (FIG. 1(a)) or the eccentricity of an optical component. There is a known phenomenon in which the deformation (θd) occurs in the entire virtual image V and the viewer is likely to feel a sense of discomfort with respect to the deformation occurring in the virtual image V. However, it is also known that this deformation is allowable when the distance difference between the upper end PU and the lower end PL of the display area VA falls within a certain range.

Here, the allowable range of the distance difference between the upper end (PU) and the lower end (PL) of the display area VA will be described with reference to FIG. 6. FIG. 6 illustrates a measurement result indicating an allowable rate of deformation when the virtual image V is arranged in the display area VA in the image formation plane in which various convergence angle differences α are set. Here, in the graph, the solid line indicates the allowable rate of deformation when the upper end PU of the display area VA is fixed at about 8 m (the distance from the viewpoint position EP of the viewer to the upper end PU of the display area VA) and the distance from the lower end PL of the display area VA is changed, and the broken line indicates the allowable rate when the upper end PU of the display area VA is fixed at about 3.4 m (the distance from the viewpoint position of the viewer to the lower end PL of the display area VA) and the distance from the lower end PL of the display area VA is changed.

According to the graph illustrated in FIG. 6, when the convergence angle difference α takes a value larger than 1°, even in two different distance zones (8 m illustrated by the solid line and 3.4 m illustrated by the broken line), it is expected that all of the subjects answer that the deformation is not allowable. In addition, when the convergence angle difference α is 1° or less, the number of subjects who feel that it is not allowable decreases as the convergence angle difference α decreases. From this, it can be understood that the convergence angle difference α between the upper end (PU) and the lower end (PL) is preferably 1° or less. In addition, it is understood that, by setting the convergence angle difference α to 0.7° or less, the deformation is allowable for more than half of the people. That is, it can be considered that setting the convergence angle difference α to 0.7° or less can sufficiently obtain an effect of preventing a feeling of discomfort due to the deformation of the virtual image V.

As specific specifications, this range includes the case where the distance (image formation distance) from the viewpoint position of the viewer to the upper end PU of the display area VA is about 8 m and the distance (image formation distance) to the lower end PL of the display area VA is about 4 m, or the case where the distance to the upper end PU of the display area VA is about 3 m and the distance to the lower end PL of the display area VA is about 2 m. Actually, the convergence angle difference α formed by the former display area VA is about 0.47°, and the convergence angle difference α formed by the latter display area VA is about 0.62°.

The convergence angle difference α is represented by an angle such as 0.5° in the same manner as the clearance described above, but the convergence angle difference α is determined by the image formation distance from the viewpoint position EP of the viewer to the upper end PU of the display area VA and the image formation distance from the viewpoint position EP of the viewer to the lower end PL of the display area VA and is “the amount for determining the specification (the difference between the distance from the viewpoint position EP of the viewer to the upper end PU of the display area VA and the distance to the lower end PL to prevent the viewer from feeling discomfort due to the deformation of the virtual image V) of the head-up display device” while the clearance is determined by the difference between the image formation distance from the viewpoint position EP of the viewer to the lower end of the virtual image V1 in the display area VA and the image formation distance from the viewpoint position EP of the viewer to the upper end of the virtual image V2 and is “the amount for determining the specific arrangement of the virtual images V1 and V2 in the display area VA when they are treated as related information”.

FIG. 3 is a schematic cross-sectional view illustrating an internal structure of the HUD device 100 according to the present embodiment, FIG. 3(a) illustrates the state of rotation of the concave mirror 141 when the eye box is at the reference position, and FIG. 3(b) illustrates the state of rotation of the concave mirror 141 when the position of the eye box is raised.

As illustrated in FIG. 3(a)(b), the HUD device 100 mainly includes the display unit 120, a first reflector 130, a second reflector 140, and a housing 150.

The display unit 120 includes the display surface 120a and outputs the display light L including light in the visible wavelength range and, for example, the light source 121 that emits white light can be used, and the liquid crystal display element 122 transmits the light emitted from the light source 121 to output the display light L including a desired image. The liquid crystal display element 122 forms a desired image based on display image data (drive signal) generated by a drawing operation performed by the control unit 160.

The first reflector 130 includes a cold mirror 131. The cold mirror 131 reflects light in a visible wavelength range (450 to 750 nm) including a light emission wavelength range of the display unit 120 at a high reflectivity of, for example, 80% or more and reflects light in a wavelength range other than the visible wavelength range at a low reflectivity. In this case, a cold mirror that reflects light in a wavelength range other than the visible wavelength range, particularly light in an infrared wavelength range (heat rays of external light such as sunlight) at a low reflectivity of, for example, 15% or less is applied as the cold mirror 131. Light that is not reflected by a reflective layer of the cold mirror 131 is configured to pass through the cold mirror 131. The cold mirror 131 can prevent the liquid crystal display element 122 from being heated to a high temperature due to sunlight or the like.

The second reflector 140 includes the concave mirror 141, which is a reflective member that reflects the display light L from the cold mirror 131 (that is, the liquid crystal display element 122), and a mirror holder 142 that holds the concave mirror 141.

In the concave mirror 141, a second reflective layer 141a is formed by vapor deposition on a resin substrate that is made of polycarbonate and has a concave surface. The concave mirror 141 is provided to be inclined at a position where the second reflective layer 141a faces the cold mirror 131 and a translucent cover 153 and is visible from the translucent cover 153.

The concave mirror 141 reflects (projects) the display light L from the cold mirror 131 toward the translucent cover 153 (the blind shield 13 of the vehicle 10) while enlarging the display light L. This means that the concave mirror 141 enlarges the display light L reflected by the cold mirror 131 and projects the enlarged display light L onto the windshield 13 through the translucent cover 153. The concave mirror 141 is bonded to the mirror holder 142 with a double-sided adhesive member. The mirror holder 142 is made of a synthetic resin such as ABS (Acrylonitrile Butadiene Styrene) and is fixed to the housing 150.

The concave mirror 141 is connected to the drive unit 110 and can be rotated within a predetermined angle range depending on the situation. Thus, the arrival point of the display light (L) in the windshield 13 can be changed. That is, the position of the eye box in the HUD device 100 changes. Therefore, it is possible to change the viewpoint position in the height direction at which the viewer who is the viewer can visually recognize the image and the display position in the display area VA in which the image is displayed.

Here, as the position of the eye box is lowered, the display position of the image (the virtual image V) in the display area VA is raised. This means that the angle of depression, which is an angle formed by two straight lines, i.e., the straight line parallel to the road surface with reference to the viewpoint position in the height direction of the viewer who is the viewer and the straight line connecting the eyes of the viewer and the image (the virtual image V), changes in a direction in which the angle of depression decreases. On the other hand, as the position of the eye box is raised, the display position of the image in the display area VA is lowered. This means that the angle of depression, which is an angle formed by two straight lines, i.e., the straight line parallel to the road surface with reference to the viewpoint position in the height direction of the viewer who is the viewer and the straight line connecting the eyes of the viewer and the image (the virtual image V), changes in a direction in which the angle of depression increases.

In other words, when the concave mirror 141 at the reference position illustrated in FIG. 3(a) rotates clockwise, the position of the eye box becomes lower as illustrated in FIG. 3(b), and conversely, when it rotates counterclockwise, the position of the eye box becomes higher.

Since the angle of depression is uniquely determined by a predetermined calculation formula in accordance with the position of the eye box, calculating the display position of the image based on the position of the eye box is equivalent to calculating the display position of the image in the display area VA based on the angle of depression.

The housing 150 is made of, for example, a black light-shielding synthetic resin material, is formed in a substantially box shape, holds and houses a projection unit including the display unit 120, the first reflector 130, and the second reflector 140 in a space portion 151 which is an internal space thereof, and includes an opening window portion 152 in which an upper portion (the windshield 13 side) of the concave mirror 141 in the second reflector 140 is opened.

In addition, the housing 150 is provided with the translucent cover 153, which is an emission portion, to close the opening window portion 152. The translucent cover 153 uses a translucent synthetic resin material (for example, acrylic resin), is formed in a curved shape (curved surface shape), and has a function as a light transmissive member through which the display light L reflected by the concave mirror 141 is transmitted (passes). That is, the display light L reflected by the cold mirror 131 and the concave mirror 141, i.e., the display light L output by the projection unit is projected onto the windshield 13 through the translucent cover 153 formed in the housing 150, and thus an image is displayed.

The HUD device 100 projects and outputs the display light L (image) on the lower side of the windshield 13. Therefore, the viewer who is the viewer can see the image superimposed on the front scenery object of the vehicle 10 from the lower area of the windshield 13. Therefore, the viewer who is the viewer mainly sees the image displayed on the road surface in the vicinity of the vehicle 10. In addition, with the configuration of the projection unit of the HUD device 100, an image is output which appears to be inclined such that the upper portion of the output image is closer to the back side than the lower portion with respect to the vehicle 10.

### Operation of Embodiment

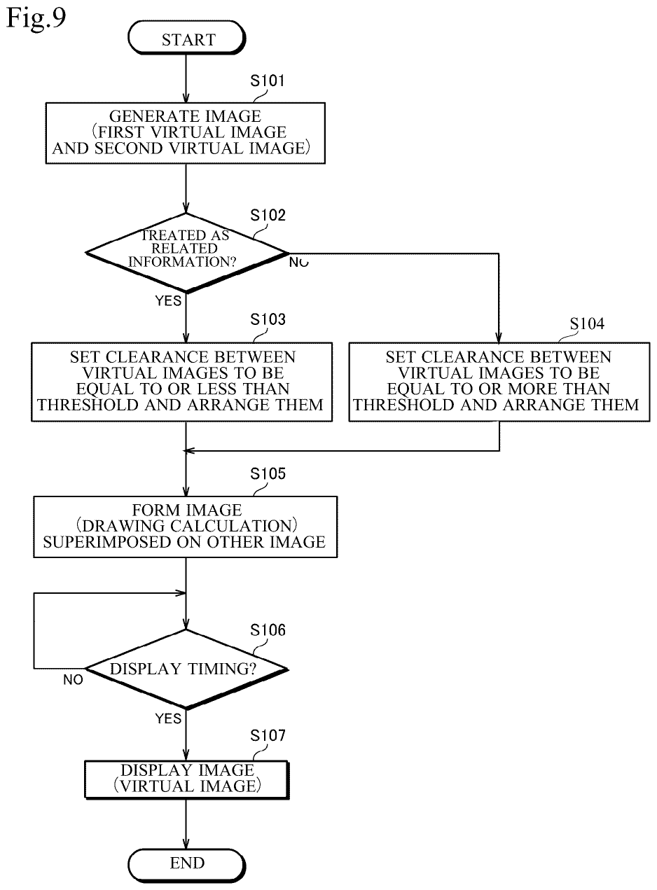

FIG. 9 is a flowchart illustrating an operation of the HUD device 100 according to the present embodiment. Further, FIG. 10 is a diagram illustrating a display form of the virtual image V by the HUD device 100 according to the present embodiment, FIG. 10(a) illustrates an example of the display form, and FIG. 10(b) illustrates another example of the display form. Hereinafter, the operation of the HUD device 100 according to the present embodiment illustrated in FIG. 2 will be described with reference to FIGS. 9, 10(a)(b).

First, the information processing unit 401 of the navigation device 400 generates the image including at least the first virtual image V1 and the second virtual image V2 to be displayed on the HUD device 100 according to the present embodiment (step S101) and outputs a display command to the HUD device 100 together with the generated image. Here, the generated image is, for example, as illustrated in an example of the display form in FIG. 10(a), the number VS1 indicating the vehicle speed, the number VS2 indicating the set vehicle speed of the ACC which is a driving assistance technique, and the sign (VS3) for vehicle speed limit arranged above or below the vehicle speed VS1. The number VS2 indicating the set vehicle speed of the ACC may be generated by the driving assistance device 300.

Subsequently, in the HUD device 100 that has received the display command, the control unit 160 determines whether the images are to be treated as related information (step S102). Here, the related information is information in which the two virtual images V1 and V2 have different meanings although they are related to each other, or the information in which it is difficult to present one piece of information unless the other piece of information is present. Examples include the number VS1 indicating the vehicle speed and the set vehicle speed VS2 of the ACC or the vehicle speed VS1 and the sign VS3 for vehicle speed limit arranged below it. They are examples of information in which, when one of them is not displayed, it is difficult to convey the meaning of the display of the other.

To be more specific, this is because, when the vehicle speed of the traveling vehicle 10 is not known, it is not possible to know whether the vehicle 10 is operating correctly in the first place even though the vehicle speed by the ACC is set, and even when the sign VS3 for vehicle speed limit is displayed, it is not possible to know whether the vehicle 10 can travel while complying with the vehicle speed in the first place. In addition, for example, the arrow VN1 indicating a turn at the next intersection in navigation such as route guidance by the navigation device 400, the virtual image VN2 indicating the remaining distance to it, and the like, are considered.

In the case where such exemplified information is visually recognized, it is considered that the load of information recognition can be reduced when the information is presented to the viewer as one piece of information instead of independent pieces of information. Specifically, when the lower left of the display area VA illustrated in FIG. 10(a) is visually recognized, it can be considered that instantaneous visual recognition of the information “the vehicle speed is currently 80 km/h (VS1), the set vehicle speed of the ACC is 100 km/h (VS2), and the vehicle speed limit is 80 km/h (VS3)” makes it easy to induce the next action of the viewer.

When it is determined that the images should be treated as related information by referring to the flag of the attribute information transmitted together with the virtual images V1 and V2 generated by the information processing unit 401 of the navigation device 400 (“YES” in step S102), the control unit 160 sets the vertical component of the angle of view AV, which is the clearance between the images to be visually recognized as related information, for example, the sign VS3 (the first virtual image V1) for vehicle speed limit and the vehicle speed VS1 (the second virtual image V2) arranged below it, to 0.6 degrees or less and arranges them in the display area VA (step S103). The same applies to the number VS1 indicating the vehicle speed and the set vehicle speed VS2 of the ACC. In addition, the arrow VN1 indicating a turn at the next intersection in navigation and the number VN2 (the second virtual image) indicating the remaining distance to it also correspond to the images treated as related information.

In the case where such exemplified information is visually recognized, it is considered that the load of information recognition can be reduced when the information is presented to the viewer as one piece of information instead of independent pieces of information. In other words, instantaneous visual recognition to the viewer that the vehicle 10 is traveling at 100 km/h on the road with the speed limit of 80 km/h while driving the vehicle 10 makes it possible to quickly induce the next action of the viewer, such as reducing the traveling speed.

Others include the bar representation indicating the number of revolutions of the engine and the number on the scale, and those indicating the destination VN1 and the remaining distance VN2 to it in navigation. These pieces of information also do not make sense when only one of them is present, and meaningful information can be presented to the viewer only when the two virtual images V1 and V2 are presented as a set. As described above, in a case where one piece of information is indicated using the two or more virtual images V1 and V2, it is desirable to design the vertical component of the angle of view AV indicating the clearance to 0.4° or less based on the above-described measurement and the evaluation result.

However, there is a possibility of unnatural arrangement when the virtual images V, which are two images having one meaning, are arranged too far from each other, and therefore, without sticking to the number such as 0.4° of the vertical component of the angle of view AV, it is better to set the clearance to a sufficiently small value (a value such as 0.1° or 0.05°) within the range in which the visibility is not remarkably impaired. For example, as illustrated in FIG. 10(a), the number VS1 indicating the vehicle speed and the set vehicle speed VS2 of the ACC may be set such that the vertical component of the angle of view indicating the clearance is 0.2°, for example. The setting of the threshold and the arrangement in the display area VA described above make it possible to instantaneously transmit two pieces of information to the viewer. Of course, the clearance may be wider or narrower than 0.2° of the vertical component of the angle of view AV.

Subsequently, in addition to arranging the first virtual image V1 and the second virtual image V2 described above in the display area VA, the control unit 160 arranges the images to be superimposed on the front scenery, which is a scenery in front of the vehicle 10, such as numbers and icons for the speed of the vehicle, the remaining energy amount, the time, and the route guidance image at desired positions, and writes the image data formed by drawing calculation in a built-in VRAM (not illustrated) having at least the same capacity as the display area VA (step S105). Then, after waiting for the display timing (“YES” in step S106), the image data is read from the VRAM and is supplied to the liquid crystal display element 122 of the display unit 120 to be displayed (step S107).

Conversely, for the image determined not to be treated as related information (“NO” in step S102) in the related information determination processing in step S102, the control unit 160 performs control to set the vertical component of the angle of view AV indicating the clearance between the generated virtual images to 0.6 degrees or more and arrange them in the display area VA (step S104).

For example, as illustrated in FIG. 10(b) as another example of the display form, a display VT1 (the second virtual image V2) for vehicle speed limit in a lower area of the display area VA indicates the speed limit of the road on which the vehicle is currently traveling. Further, a display VT2 (the first virtual image V1) for vehicle speed limit in an upper area of the display area VA indicates the speed limit of the most recent road. The virtual images V1 and V2 are information having independent meanings, and therefore, when they are too close to each other and appear as the identical information group, it may take a long time for the viewer to determine what information is meant. For example, when the display VT1 (the first virtual image V1) for vehicle speed limit and the display VT2 (the second virtual image V2) for vehicle speed limit are arranged to be displayed substantially in parallel, it is difficult to quickly recognize what the vehicle speed limit of the road on which the vehicle is currently traveling is.

As described above, for some types of information, setting a small clearance makes it difficult to divide the information, and it may be difficult to transmit the information to the viewer. That is, when there is a need to ensure that different types of information are transmitted as separate information to the viewer, it is necessary to arrange the images with a certain degree of clearance, contrary to the above description. In other words, contrary to the above-described measurement results, when a clearance of at least 0.6° or more is provided, more than half of viewers can perceive the information as separate information. By doing so, it is possible to quickly notify that the information is different, and it is possible to transmit the information to the viewer in a more easily understandable manner.

Subsequently, in addition to arranging the first virtual image V1 and the second virtual image V2 described above in the display area VA, the control unit 160 arranges the images to be superimposed on the front scenery, which is a scenery in front of the vehicle 10, such as numbers and icons for the speed of the vehicle 10, the remaining energy amount, the time, and the route guidance image at desired positions, and writes the image data formed by drawing calculation in a built-in VRAM (not illustrated) having at least the same capacity as the display area VA (step S105). Then, after waiting for the display timing (“YES” in step S106), the image data is read from the VRAM and supplied to the liquid crystal display element 122 of the display unit 120 to be displayed (step S107).

### Modification

In the description of the HUD device 100 according to the present embodiment described above, the information processing unit 401 of the navigation device 400 generates the image including the first virtual image V1 and the second virtual image V2 and issues a display command to the HUD device 100, and when the first virtual image V1 and the second virtual image V2 are treated as information related to each other, the HUD device 100, which has received the display command, sets the spacing (clearance) between the lower end of the first virtual image V1 and the upper end of the second virtual image V2 arranged in the display area VA to be equal to or less than a predetermined threshold (for example, the vertical component of the angle of view AV is 0.6°) determined by the difference between the image formation distance from the viewpoint position of the viewer to the lower end of the first virtual image V1 in the display area VA and the image formation distance from the viewpoint position of the viewer to the upper end of the second virtual image V2, and performs control to display the first virtual image V1 and the second virtual image V2 on the display unit 120; however, the function for generating an image may be performed by not only the navigation device 400 (the information processing unit 401) but also the driving assistance device 300 instead. In addition, the HUD device 100 may also have a function of generating an image independently of the navigation device 400 and the driving assistance device 300, and may perform the function independently.

Further, the HUD device 100 may be regarded as a simple display device that performs only display control, and the navigation device 400 (the information processing unit 401) or the driving assistance device 300 may be configured to generate the image including the first virtual image V1 and the second virtual image V2 and, when the first virtual image V1 and the second virtual image V2 are treated as information related to each other, set the spacing (clearance) between the lower end of the first virtual image V1 and the upper end of the second virtual image V2 arranged in the display area VA to be equal to or less than a predetermined threshold (for example, the vertical component of the angle of view AV is 0.6°) determined by the difference between the image formation distance from the viewpoint position of the viewer to the lower end of the first virtual image V1 in the display area VA and the image formation distance from the viewpoint position of the viewer to the upper end of the second virtual image V2, and output a display command to the HUD device 100.

### Effect of Embodiment

As described above, the head-up display device according to the present embodiment is the HUD device 100 that causes the viewer to visually recognize the virtual image V by projecting and displaying the virtual image V in the display area VA virtually set in front of the vehicle 10 in a superimposed manner on the front scenery, as illustrated in for example FIG. 1(a)(b). For example, as illustrated in FIG. 2, the HUD device 100 includes the display unit 120 that projects and displays the first virtual image V1 and the second virtual image V2 in the display area VA, and the control unit 160 that performs control to display, on the display unit 120, the first virtual image V1 arranged in the display area VA and the second virtual image V2 arranged below the first virtual image V1. For example, as illustrated in FIG. 9, when the first virtual image V1 and the second virtual image V2 are treated as information related to each other (“YES” in step S102), the control unit 160 sets the spacing (clearance) between the lower end of the first virtual image V1 and the upper end of the second virtual image V2 arranged in the display area VA to be equal to or less than a predetermined threshold (for example, the vertical component of the angle of view AV is 0.6°) determined by the difference between the image formation distance from the viewpoint position of the viewer to the lower end of the first virtual image V1 in the display area VA and the image formation distance from the viewpoint position of the viewer to the upper end of the second virtual image (step S103), and performs control to display the first virtual image V1 and the second virtual image V2 on the display unit 120.

With the HUD device 100 according to the present embodiment, when the first virtual image V1 and the second virtual image V2 are treated as information related to each other (which correspond to, as illustrated in for example FIG. 10(a), the sign VS3 for vehicle speed limit and the number VS1 that is arranged below it and indicates the vehicle speed of the traveling vehicle, or the arrow VN1 indicating a turn at the next intersection and the number VN2 indicating the remaining distance to it in navigation and, in this case, the first virtual image V1 is the sign VS3 for vehicle speed limit, and the second virtual image is the number VS1 indicating the vehicle speed), the control unit 160 sets the spacing (clearance) between the lower end of the first virtual image V1 and the upper end of the second virtual image V2 arranged in the display area VA to be equal to or less than a predetermined threshold (for example, the vertical component of the angle of view AV is 0.6°) determined by the difference between the image formation distance from the viewpoint position of the viewer to the lower end of the first virtual image V1 in the display area VA and the image formation distance from the viewpoint position of the viewer to the upper end of the second virtual image V2 and performs control to display the first virtual image V1 and the second virtual image V2 on the display unit 120. In this way, the first virtual image V1 and the second virtual image V2 can be appropriately arranged in accordance with the spacing (clearance) between the virtual images V with which it is possible to perceive that the two virtual images V1 and V2 mean one piece of information, and accordingly, the accurate information can be transmitted to the viewer.

In addition, with the HUD device 100 according to the present embodiment, the control unit 160 treats the first virtual image V1 and the second virtual image V2 as the information that have a meaning using at least the two virtual images and are related to each other and thus can reduce a load for information recognition. For example, when the sign VS3 (the first virtual image V1) for vehicle speed limit and the vehicle speed VS1 (the second virtual image V2) arranged below it are treated as related information, instantaneous visual recognition of traveling at 100 km/h on the road with the speed limit of 80 km/h is possible, and the next action of the viewer, such as reducing the traveling speed, can be quickly induced.

In addition, with the HUD device 100 according to the present embodiment, the control unit 160 designs the arrangement of the virtual images V1 and V2 such that the clearance between the virtual images V1 and V2 is 0.6° or less regardless of where they are arranged in the display area VA, which is virtually set in front of the vehicle 10, so that many viewers can perceive them as the identical information group. In other words, the virtual images V1 and V2 can be appropriately arranged in accordance with the clearance (the vertical component of the angle of view is 0.6° or less) with which it is possible to perceive that the two virtual images V1 and V2 mean one piece of information, and accordingly, the accurate information can be transmitted to the viewer.

In addition, with the HUD device 100 according to the present embodiment, the control unit 160 can perform display with enhanced expressiveness in the depth direction (the front-rear direction of the vehicle) by using the display area VA that is an inclined image formation plane in which the upper end (for example, PU of the angle of view AV in FIG. 1(b)) of the display area VA is closer to the back side than the lower end (for example, PL of the angle of view AV in FIG. 1(b)), and can realize visibility of a more natural and perspective image.

Furthermore, with the HUD device 100 according to the present embodiment, the control unit 160 sets the convergence angle difference α, which is a difference between the first convergence angle with respect to the first point R1 at the upper end PU of the display area VA and the convergence angle with respect to the second point R2 at the lower end PL of the display area VA, to 1.0° or less and thus, in the HUD device 100 in which the display area VA is inclined, can sufficiently obtain the effect to the extent that a sense of discomfort due to the deformation of the virtual image V is prevented even when the shape of the entire virtual image V arranged in the display area VA is deformed due to the binocular parallax or the motion parallax caused by the viewpoint movement of the driver who is the viewer. As specific specifications, this range includes the case where the distance (image formation distance) from the viewpoint position of the viewer in the height direction to the upper end PU of the display area VA is about 8 m and the distance (image formation distance) to the lower end PL of the display area VA is about 4 m, or the case where the distance to the upper end PU of the display area VA is about 3 m and the distance to the lower end PL of the display area VA is about 2 m. Actually, the convergence angle difference α formed by the former display area VA is about 0.47°, and the convergence angle difference formed by the latter display area VA is about 0.62°.

For example, as illustrated in FIG. 2, the display control system according to the present embodiment is a display control system (for example, the vehicle control system 1000) including a head-up display device (the HUD device 100) that projects and displays the virtual image V in the display area VA virtually set in front of the vehicle 10 in a superimposed manner on the front scenery and a processing device (for example, the information processing unit 401 of the navigation device 400) that generates the virtual image V. Further, the HUD device 100 includes the display unit 120 that projects and displays the first virtual image V1 and the second virtual image V2 in the display area VA and the control unit 160 that performs control to display, on the display unit 120, the first virtual image V1 arranged in the display area VA and the second virtual image V2 arranged below the first virtual image V1. When the first virtual image V1 and the second virtual image V2 are treated as information related to each other, the processing device (the information processing unit 401 of the navigation device 400) sets the spacing between the lower end of the first virtual image V1 and the upper end of the second virtual image V2 arranged in the display area VA to be equal to or less than a predetermined threshold determined by the difference between the image formation distance from the viewpoint position of the viewer to the lower end of the first virtual image V1 in the display area VA and the image formation distance from the viewpoint position of the viewer to the upper end of the second virtual image V2 and gives an instruction to the HUD device 100 to display the first virtual image V1 and the second virtual image V2.

With the display control system (the vehicle control system 1000) according to the present embodiment, when the first virtual image V1 and the second virtual image V2 are treated as information related to each other, the processing device (information processing unit) 401 sets the spacing between the lower end of the first virtual image V1 and the upper end of the second virtual image V2 arranged in the display area VA to be equal to or less than the predetermined threshold determined by the difference between the image formation distance from the viewpoint position of the viewer to the lower end of the first virtual image V1 in the display area VA and the image formation distance from the viewpoint position of the viewer to the upper end of the second virtual image V2 and controls the HUD device 100 to display the first virtual image V1 and the second virtual image v2. In this way, it is possible to provide the display control system capable of appropriately arranging the first virtual image V1 and the second virtual image V2 in accordance with the spacing (clearance) between the virtual images, with which it is possible to perceive that the two virtual images V1 and V2 mean one piece of information, and accordingly transmitting the accurate information to the viewer.

In the display control system (the vehicle control system 1000) according to the present embodiment, a function executed by the processing device (for example, the information processing unit 401 included in the navigation device 400) is performed by a program executed by a computer. In this case, the information processing unit 401 includes a computer including at least one control device (for example, a processor) and at least one storage device (for example, a RAM) as hardware for executing the above-described program.

In addition, the above-described program is not temporary, and may be recorded in one or more computer-readable recording media. The recording medium may or may not be included in the information processing unit 401. In the latter case, the above-described program may be supplied to the above-described information processing unit 401 via any wired or wireless transmission medium.

In addition, at least a part of the above-described functions can be realized by a logic circuit. For example, an integrated circuit in which a logic circuit is formed is also included in the scope of the present invention. In addition, for example, the above-described functions can be realized by a quantum computer. In addition, each processing described in the present embodiment may be executed by AI (artificial intelligence). In this case, the AI may operate in the information processing unit 401 or may operate in another device (for example, a cloud server).

The present invention is not limited to the exemplary embodiments described above, and a person skilled in the art can easily modify the exemplary embodiments described above to the extent that they fall within the scope of the claims.

### DESCRIPTION OF REFERENCE NUMERALS

100 HEAD-UP DISPLAY DEVICE (HUD DEVICE)
110 DRIVE UNIT
120 DISPLAY UNIT
120a DISPLAY SURFACE
121 LIGHT SOURCE
122 LIQUID CRYSTAL DISPLAY ELEMENT
141 CONCAVE MIRROR
160 CONTROL UNIT
200 VEHICLE-MOUNTED SENSING DEVICE
300 DRIVING ASSISTANCE DEVICE
400 NAVIGATION DEVICE
500 OPERATION INPUT DEVICE
1000 VEHICLE CONTROL SYSTEM (DISPLAY CONTROL SYSTEM)
A1, A2, CO CENTER OF EYES
PL LOWER END OF DISPLAY AREA
PU UPPER END OF DISPLAY AREA
R1 FIRST POINT
R2 SECOND POINT
V VIRTUAL IMAGE
V1 FIRST VIRTUAL IMAGE
V2 SECOND VIRTUAL IMAGE
VA DISPLAY AREA
VN1 NAVIGATION DISPLAY (ARROW)
VN2 REMAINING DISTANCE DISPLAY
VP PERSPECTIVE IMAGE
VS1 NUMBER INDICATING VEHICLE SPEED
VS2 CHARACTERS INDICATING VEHICLE SPEED LIMIT
VS3 VEHICLE SPEED LIMIT OF CURRENT ROAD
VT1 VEHICLE SPEED LIMIT OF CURRENT ROAD
VT2 VEHICLE SPEED LIMIT OF MOST RECENT ROAD
α CONVERGENCE ANGLE DIFFERENCE

1. A head-up display device that projects and displays a virtual image in a display area virtually set in front of a vehicle in a superimposed manner on a front scenery and thus causes a viewer to visually recognize the virtual image, the head-up display device comprising:
a display unit that projects and displays a first virtual image and a second virtual image in the display area; and
a control unit that performs control to display, on the display unit, the first virtual image arranged in the display area and the second virtual image arranged below the first virtual image, wherein
when the first virtual image and the second virtual image are treated as information related to each other, the control unit sets a spacing between a lower end of the first virtual image and an upper end of the second virtual image arranged in the display area to be equal to or less than a predetermined threshold determined by a difference between an image formation distance from a viewpoint position of the viewer to the lower end of the first virtual image in the display area and an image formation distance from the viewpoint position of the viewer to the upper end of the second virtual image, and performs control to display the first virtual image and the second virtual image on the display unit.

2. The head-up display device according to claim 1, wherein the control unit treats the first virtual image and the second virtual image as information that have a meaning using at least the two virtual images and are related to each other.

3. The head-up display device according to claim 1, wherein the control unit sets the predetermined threshold such that a vertical component of an angle of view indicating the spacing between the lower end of the first virtual image and the upper end of the second virtual image is 0.6° or less.

4. The head-up display device according to claim 1, wherein, when a side of the display area closer to the viewer is set as a lower end and a farther side is set as an upper end, the control unit performs control so that the display area is displayed to be visually recognized by the viewer in an inclined manner such that the upper end is closer to a back side than the lower end.

5. The head-up display device according to claim 4, wherein the control unit sets a convergence angle difference, which is a difference between a first convergence angle with respect to a first point at an upper end of the display area and a convergence angle with respect to a second point at a lower end of the display area, to 1.0° or less.

6. A display control system comprising:
a head-up display device that projects and displays a virtual image in a display area virtually set in front of a vehicle in a superimposed manner on a front scenery; and
a processing device that generates the virtual image, wherein
the head-up display device includes
a display unit that projects and displays a first virtual image and a second virtual image in the display area, and
a control unit that performs control to display, on the display unit, the first virtual image arranged in the display area and the second virtual image arranged below the first virtual image, and
when the first virtual image and the second virtual image are treated as information related to each other, the processing device sets a spacing between a lower end of the first virtual image and an upper end of the second virtual image arranged in the display area to be equal to or less than a predetermined threshold determined by a difference between an image formation distance from a viewpoint position of the viewer to the lower end of the first virtual image in the display area and an image formation distance from the viewpoint position of the viewer to the upper end of the second virtual image and gives an instruction to the head-up display device to display the first virtual image and the second virtual image.
